(19) United States
(12) Patent Application Publication
(10) Pub. No.: US 2013/0064198 A1
(43) Pub. Date: Mar. 14, 2013

(54) MULTIPATH TRANSPORT TUNNEL OVER MULTIPLE AIR INTERFACES CONNECTING WIRELESS STATIONS

(71) Applicants: Dilip KRISHNASWAMY, San Diego, CA (US); Peerapol TINNAKORNSRISUPHAP, San Diego, CA (US)

(72) Inventors: Dilip KRISHNASWAMY, San Diego, CA (US); Peerapol TINNAKORNSRISUPHAP, San Diego, CA (US)

(73) Assignee: QUALCOMM Incorporated, San Diego, CA (US)

(21) Appl. No.: 13/614,900

(22) Filed: Sep. 13, 2012

Related U.S. Application Data
(60) Provisional application No. 61/534,824, filed on Sep. 14, 2011.

(51) Int. Cl. H04W 72/04

(52) U.S. Cl. 370/329

(57) ABSTRACT

A method and apparatus for wireless communication between stations addressable via an Internet Protocol (IP) network that includes a first station wirelessly communicating with a second station via a multi-path transport protocol (MTP) tunnel The MTP tunnel manages at least a first IP data sub-flow over a first air interface and at least a second IP data sub-flow over a second air interface and allocates a first IP data flow to the at least two distinct IP data sub-flows over the at least two distinct air interfaces.

The present application claims priority to provisional U.S. Application Ser. No. 61/534,824, filed Sep. 14, 2011, which is incorporated herein by reference.

### BACKGROUND

I. Field

The following description relates generally to wireless communications systems, and more particularly to wireless connectivity between wireless stations, such as between an access terminal and an access point.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems. Each of the foregoing systems operates over licensed frequency spectrums, and licensee operators generally provide access to users according to a subscription model. The technology described herein pertains to these and similar systems.

Orthogonal frequency division multiplex (OFDM) may be used to describe a communication system that partitions the overall system bandwidth into multiple (N_{F}) subcarriers, which may also be referred to as frequency sub-channels, tones, or frequency bins. In an OFDM system, the data to be transmitted (i.e., the information bits) may be first encoded with a particular coding scheme to generate coded bits, and the coded bits further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier.

Generally, a wireless multiple-access communication system can concurrently support communication for multiple wireless terminals such as mobile entities that communicate with one or more base stations via transmissions on forward and reverse links. The forward link (or downlink) refers to the communication link from the base stations to the mobile entities, and the reverse link (or uplink) refers to the communication link from the mobile entities to the base stations. This communication link may be established via a single-in-single-out, multiple-in-signal-out or a multiple-in-multiple-out (MIMO) system.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels. Generally, each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to transmit beam-forming gain on the forward link when multiple antennas are available at the access point.

In addition, a new class of small base stations for providing access to wireless communication systems has emerged, which may be installed in a user's home and provide indoor wireless coverage to mobile units using existing broadband Internet connections. Such a base station is generally known as a femtocell access point (FAP), but may also be referred to as Home Node B (HNB) unit, Home evolved Node B unit (HeNB), femtocell, femto Base Station (fBS), base station, or base station transceiver system. Such terms may be used interchangeably herein. Typically, the femto access point is coupled to the Internet and the mobile operator's network via a Digital Subscriber Line (DSL), fiber optic, cable internet access, T1/T3, or other wired backhaul connection, and offers typical base station functionality, such as Base Transceiver Station (BTS) technology, radio network controller, and gateway support node services. This allows an Access Terminal (AT), also referred to as User Equipment (UE) (for example, a cellular/mobile device or handset, Mobile Station (MS), Mobile Entity (ME)) to communicate with the femtocell access point and utilize the wireless service.

One characteristic of a femtocell may include communicating over with an application server or other node over the Internet using a wired backhaul, while relaying downlink data to (or uplink data from) one or more access terminals over a wireless air interface. Air interfaces used for coupling wireless access terminals to a femtocell may have a lower bandwidth than the wired backhaul. For example, wireless wide area network (WWAN) or wireless local area network (WLAN) air interfaces may provide bandwidths in the range of about 20 to 40 MHz, with peak downlink data transfer rates in the range of about 50 to 100 megabits per second (Mbps). In comparison, various wired Internet Protocol (IP) interfaces may provide much higher data transfer rates on the order of the gigabits per second (Gbps). Accordingly, an air interface between a femtocell and a wireless access terminal may impose a bottleneck on data transfer rates between the access terminal and an application server or other network node. As access terminals served by femtocells are increasingly used for downloading video or other high data rate content from an Internet server, this bottleneck may create an adverse impact on the user experience under some conditions.

### SUMMARY

The following presents a simplified summary in order to provide a basic understanding of some aspects of the claimed subject matter. This summary is not an extensive overview, and is not intended to identify all key/critical elements or to delineate the scope of the claimed subject matter. Its purpose is to present some concepts in a simplified form as a prelude to the more detailed description that is presented later. Although examples, methodologies and apparatus are generally described as implemented at a femtocell access point or an access terminal communicating with the femtocell, it should be appreciated that features disclosed herein may be implemented in any wireless access point or access terminal where such features may provide some benefit.

In accordance with one or more embodiments and corresponding disclosure thereof, various aspects are described in connection with methods for providing a multipath transport protocol (MTP) tunnel over multiple air interfaces connecting wireless stations. The methods may be performed in a wireless communication network comprising at least one femto access point (FAP) configured for wireless communication with at least one access terminal accessing the network via the FAP. The wireless communication network may include an IP packet-switched network connected to the FAP via a backhaul connection and an access terminal connected to the FAP via at least two distinct air interfaces. The at least two distinct air interfaces may be configured in parallel, meaning that the FAP and the access terminal are within wireless range of each other via either or both of the air interfaces. Thus, for example, a signal wirelessly transmitted from the FAP over any one of the distinct air interfaces can be received by the access terminal, and vice-versa.

In the summary and detailed description that follows, each of the FAP and the access terminal may be referred to as a wireless station, or in short as a station. In some examples, the term “first station” may refer to either one of a FAP and an access terminal, while the term “second station” refers to a corresponding other one of these entities. In such examples, the described operations or aspects may apply either to a FAP in communication with an access terminal, or to an access terminal in communication with a FAP, without excluding other wireless stations having attributes as described in the examples. In addition, in further examples the term “first station” is definitely identified as referring to an access point, for example, to a FAP or femtocell. Conversely, the term “first station” is definitely identified as referring to an access terminal in other examples.

In an aspect, a method for wireless communication between stations that are addressable via an IP network may be performed at a first wireless station, for example, at a femtocell. As used herein, “addressable” means that the stations are capable of being addressed using an IP address; for example, the stations may perform transmission control using a protocol that recognizes and uses IP addresses. In an aspect, an access terminal using the method may receive data and communicate with an application server via an IP connection passing through a FAP or other access point. The method may include at a first station, wirelessly communicating with a second station via a multi-path transport protocol (MTP) tunnel component that manages at least two distinct IP data sub-flows over at least two distinct air interfaces. The first station and the second station may be in wireless communications range of each other via the at least two distinct air interfaces. The distinct air interfaces may be arranged to provide parallel wireless links between the wireless stations, which may be used concurrently, or non-concurrently.

In another aspect, the method may include allocating a first IP data flow to the at least two distinct IP data sub-flows over the at least two distinct air interfaces, using the MTP tunnel component of the first station. The first station may receive the first IP data flow addressed to the first station using a single address of the IP network. The MTP tunnel component may be used to initiate or “wrap” a packet data tunnel that can use any one of, any combination of, or all of the distinct air interfaces. In an aspect, allocating the first IP data flow may be managed to cause the at least two distinct IP data sub-flows to occur concurrently over the at least two distinct air interfaces. In the alternative, or in addition, allocating the first IP data flow may be managed to cause the at least two distinct IP data sub-flows to occur non-concurrently (e.g., sequentially) over the at least two distinct air interfaces. The MTP tunnel component may also be used to terminate or “unwrap” a packet data tunnel for data the component receives over the at least two air interfaces. Accordingly, the method may further include aggregating the at least two distinct IP data sub-flows from the at least two distinct air interfaces into a second IP data flow, using the MTP tunnel component of the first station.

In another aspect, the method may further include mediating IP packet data between a network layer for an application layer and respective network layers for each of the at least two distinct air interfaces, using the MTP tunnel component. Accordingly, the first station may be, or may include, an access terminal operating an application, wherein the MTP tunnel component mediates between the at least two distinct air interfaces and the application.

Conversely, in another aspect, the method may further include mediating IP packet data between a network layer for the IP network and respective network layers for the at least two distinct air interfaces, using the MTP tunnel component. According to this aspect, the first station may be, or may include, a wireless access point coupled to the IP network, wherein the MTP tunnel component mediates between the at least two distinct air interfaces and the IP network. For example, the access point may be, or may include, a femtocell. In such case, the method may further include communicating with the IP network from the first station via a wired backhaul connection.

The method may further include further comprising operating the MTP tunnel component according to a standard Multipath Transmission Control Protocol (MPTCP) of the IP network. This can include creating a TCP sub-flow for each IP data flow over each air interface. The MPTCP layer splits data across the TCP sub-flows based on available performance over each sub-flow such as based on an estimate of the congestion window size. The MPTCP layer performs congestion avoidance and retransmissions on each of the TCP sub-flows, based on acknowledgements received regarding missing and/or received TCP data segments. Alternatively, the SCTP (Stream Control Transmission Protocol) may be used across the IP data flows. Furthermore, TCP may not be optimized for operating over relatively short network links, such as may exist between a femtocell and an access terminal in wireless proximity to the femtocell. Accordingly, the method may further include operating the MTP tunnel component according to a special multipath transport protocol that is configured for the at least two distinct air interfaces, and is distinct from a standard Multipath Transmission Control Protocol (MPTCP). This special multipath transport protocol can be a variant of a standard multipath TCP implementation such that congestion avoidance is performed based on explicit knowledge of the performance (such as MAC-layer throughput and/or the physical layer throughput and/or the physical layer modulation and coding scheme and/or the packet error rate) of each wireless link. The special transport protocol may be optimized for tunneling over two or more direct air links between proximal wireless stations. In an aspect, the method may further include adapting operation of the MTP tunnel component in response to wireless link conditions between the first station and the second station. That is, the wireless station may provide a “smart” link-aware adaptation based on current wireless link conditions. For example, the method may further include directing packets from the first IP data flow to one of the at least two distinct IP data sub-flows that is selected based on at least one of: (i) current and past radio conditions (ii) packet loss rate (iii) buffer size, or (iv) estimated latency; wherein the foregoing parameters (i)-(iv) pertain to respective ones of the at least two distinct air interfaces. In other aspects, the special multipath transportprotocol could be a multipath UDP transport protocol, such that IP data packets is delivered on forward UDP sub-flows between the two stations. Reverse UDP sub-flows can be used to provide feedback on received IP data packets. Redundancy using reed-solomon codes or raptor codes can be used to deliver redundant data packets on the forward or reverse UDP sub-flows to ensure transport layer redundancy for delivery of information. The multipath UDP transport protocol proportionately distributes packets across the sub-flows based on the available performance for each of the sub-flows. In other aspects, a selection can be made between concurrent aggregation and robust modes of operation to concurrently utilize both wireless links for increased throughput, or to dynamically select the best wireless link respectively for robust operation.

In other aspects, the method may further include transmitting and receiving over a first one of the at least two distinct air interfaces configured as a Wireless Wide Area Network (WWAN) air interface; for example, an LTE interface. Likewise, the method may further include transmitting and receiving over a second one of the at least two distinct air interfaces configured as a Wireless Local Area Network (WLAN) air interface. In the alternative, or in addition, the second one of the at least two distinct air interfaces comprises a Worldwide Interoperability for Microwave Access (WiMAX) air interface. Other air interface configurations may also be used. The first station may transmit and receive the at least two distinct air interfaces in distinct portions of a radio spectrum. That is each air interface may use different, non-overlapping spectrum and thereby may be capable of being used concurrently.

In related aspects, a communications apparatus may be provided for performing any of the methods and related aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as mobile entities of various types used for wireless communications. Similarly, an article of manufacture may be provided, including a non-transient computer-readable storage medium holding encoded instructions, which when executed by a processor, may cause a communications apparatus to perform the methods and aspects of the methods as summarized above.

The foregoing methods and apparatus may confer various advantages and benefits. These benefits may include providing more robust and additive connectivity between the wireless stations. For example, a WWAN (e.g., 3G/4G) interface may be used as a fall-back if a parallel WLAN air interface experiences transient connectivity issues, or vice-versa, in a primarily non-concurrent use of the multiple air interface links. Meanwhile, the transition between different air interfaces is seamless and invisible to any application passing data through the MTP tunnel component. Bandwidth aggregation may greatly increase data transfer rates between the wireless stations, in a primarily concurrent use of the multiple air interfaces. Value may be realized for enterprise FAP's by using the air interfaces concurrently to more fully exploit the capabilities of a high bandwidth backhaul connection. Further advantages may reside in smart link-aware adaptation. A FAP may adapt to link conditions on downlink paths, while a client access terminal may adapt based on link conditions on downlink paths. In both cases, the MTP tunnel component may be directly aware of wireless link conditions without the need for receiving feedback from some other network component. A further advantage may be realizing by eliminating the need for an anchor between distinct air interfaces (e.g., WWAN or WLAN) at a higher-level network location. The anchor component may placed in the FAP itself, which may select the best link for current conditions or utilize multiple links if desired.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Throughout the drawings and accompanying description, like reference characters identify correspondingly like elements.

FIG. 1 illustrates a multiple access wireless communication system including a mobile entity and a base station.

FIG. 2 is a block diagram illustrating a communication system.

FIG. 3 illustrates an example of a wireless communication system.

FIG. 4 illustrates an example of a communication system including an IP-addressable femto access point and access terminal within a network environment.

FIGS. 5-5D illustrate various configurations of a femto access point and access terminal both incorporating MTP tunnel component(s).

FIG. 6 is a flow diagram showing an example of a method for wireless communication between wireless stations, using an MTP tunnel component and multiple air interfaces.

FIGS. 7-11 are flow diagrams illustrating additional aspects and operations of the method shown in FIG. 6.

FIG. 13 is a block diagram showing an example of an apparatus for performing a method as shown in FIG. 6.

### DETAILED DESCRIPTION

Systems, apparatus and methods are provided using an access point or an access terminal to tunnel IP packet data over multiple air interfaces, to realize advantages and benefits as summarized above.

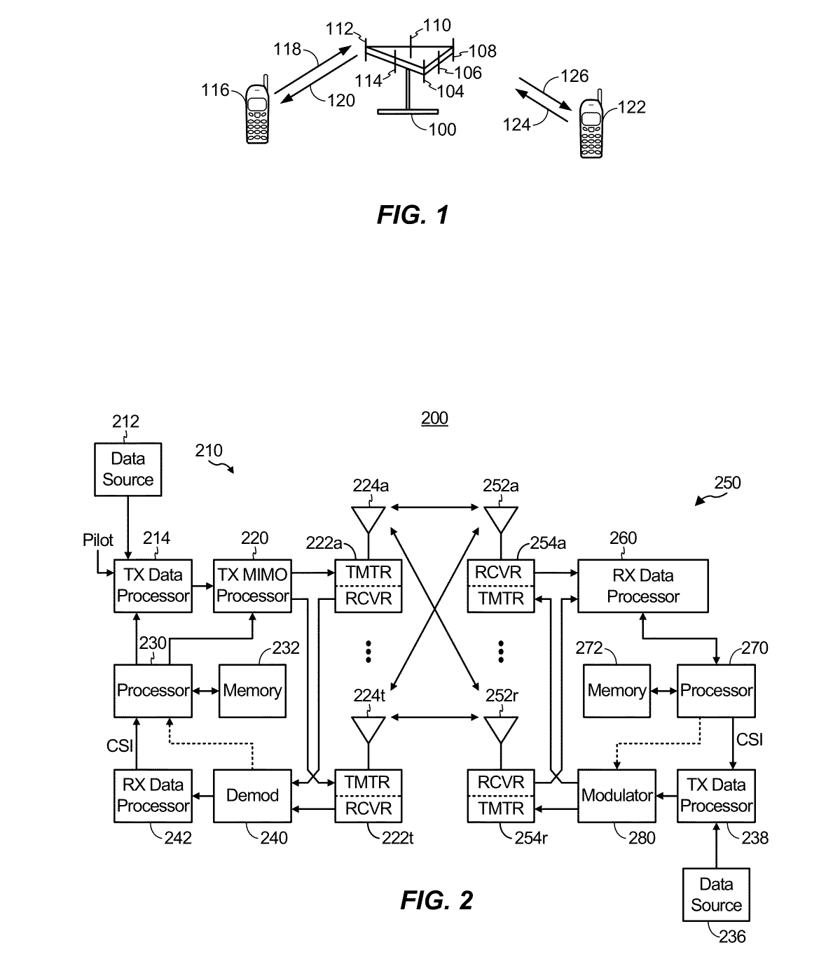

Before describing specific details pertinent to creating and maintaining NCLs for femto access points or similar base stations, examples of contexts in which the described details should be useful will first be provided. Referring to FIG. 1, an example of a multiple access wireless communication system context is illustrated. An access point 100 (e.g., base station, Evolved Node B (eNB), or the like) may include multiple antenna groups, one including 104 and 106, another including 108 and 110, and an additional group including 112 and 114. In FIG. 1, two antennas are shown for each antenna group, however, more or fewer antennas may be utilized for each antenna group. A mobile entity 116 (ME) is in communication with the antennas 112 and 114, where the antennas 112 and 114 transmit information to the ME 116 over a forward link 120 and receive information from the ME 116 over a reverse link 118. An ME 122 is in communication with the antennas 106 and 108, where the antennas 106 and 108 transmit information to the ME 122 over a forward link 126 and receive information from the ME 122 over a reverse link 124. In a FDD system, the communication links 118, 120, 124 and 126 may use different frequency for communication. For example, the forward link 120 may use a different frequency then that used by the reverse link 118.

Each group of antennas and/or the area in which they are designed to communicate is often referred to as a sector of the access point. In the embodiment, antenna groups each are designed to communicate to MEs in a sector, of the areas covered by the access point 100. An access point may operate different cells using different antenna groups.

In communication over the forward links 120 and 126, the transmitting antennas of the access point 100 may utilize beamforming in order to improve the signal-to-noise ratio of forward links for the different MEs 116 and 124. Also, an access point using beamforming to transmit to MEs scattered randomly through its coverage causes less interference to MEs in neighboring cells than an access point transmitting through a single antenna to all its MEs.

FIG. 2 is a block diagram of an embodiment of a transmitter system 210 (also known as the access point) and a receiver system 250 (also known as an access terminal) in a MIMO system 200. At the transmitter system 210, traffic data for a number of data streams may be provided from a data source 212 to a transmit (TX) data processor 214.

In an embodiment, each data stream is transmitted over a respective transmit antenna. The TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase Shift Keying (QSPK), M-ary Phase-Shift Keying (M-PSK), or Multi-Level Quadrature Amplitude Modulation (M-QAM)) selected for that data stream to provide modulation symbols. The data rate, coding, and modulation for each data stream may be determined by instructions performed by a processor 230.

The modulation symbols for all data streams are then provided to a TX MIMO processor 220, which may further process the modulation symbols (e.g., for OFDM). The TX MIMO processor 220 then provides N_{T} modulation symbol streams to N_{T} transmitters (TMTR) 222a through 222t. In certain embodiments, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At the receiver system 250, the transmitted modulated signals are received by N_{R} antennas 252a through 252r and the received signal from each antenna 252a through 252r may be provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from the N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by the RX data processor 260 is complementary to that performed by the TX MIMO processor 220 and the TX data processor 214 at the transmitter system 210.

A processor 270 periodically determines which pre-coding matrix to use, discussed further below. The processor 270 formulates a reverse link message comprising a matrix index portion and a rank value portion. The processor 270 may be coupled to a memory 272 holding program instructions and data. The processor 270, or a separate processor, may be used to implement an MTP tunnel component as described elsewhere herein.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by the antennas 224, conditioned by the receivers 222, demodulated by a demodulator 240, and processed by a RX data processor 242 to extract the reserve link message transmitted by the receiver system 250. The processor 230 then determines which pre-coding matrix to use for determining the beamforming weights then processes the extracted message. The processor 230 may be coupled to a memory 232 holding program instructions and data. The processor 270, or a separate processor, may be used to implement an MTP tunnel component as described elsewhere herein.

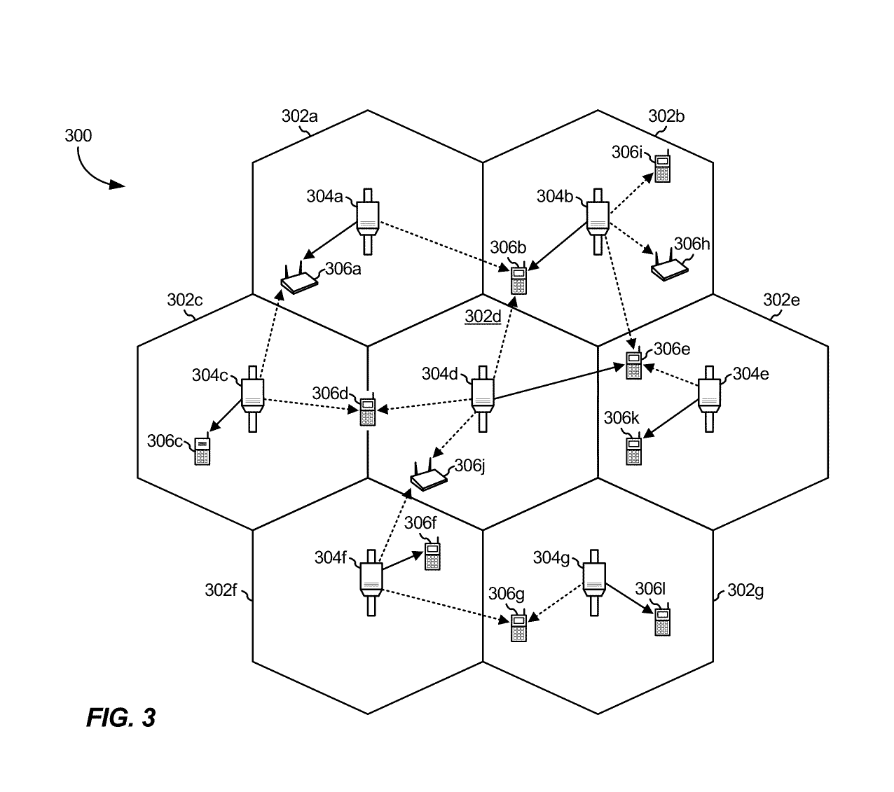

FIG. 3 illustrates an example of a wireless communication system 300 configured to support a number of users, in which various disclosed embodiments and aspects may be implemented. As shown in FIG. 3, by way of example, the system 300 provides communication for multiple cells 302, such as, for example, macro cells 302a-302g, with each cell being serviced by a corresponding access point (AP) 304 (such as APs 304a-304g). Each cell may be further divided into one or more sectors. Various MEs 306, including MEs 306a-306k, also known interchangeably as UEs or access terminals, are dispersed throughout the system. Each ME 306 may communicate with one or more APs 304 on a forward link (FL) and/or a reverse link (RL) at a given moment, depending upon whether the ME is active and whether it is in soft handoff, for example. The wireless communication system 300 may provide service over a large geographic region, for example, the macro cells 302a-302g may cover a few blocks in a neighborhood.

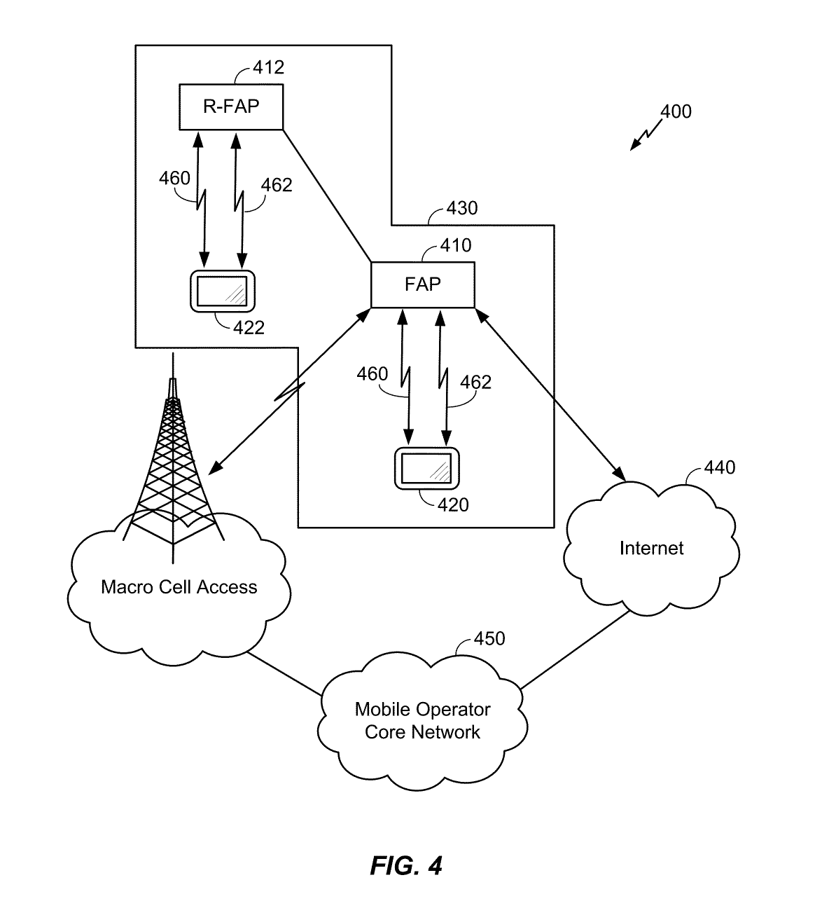

FIG. 4 illustrates an example of a communication system 400 to enable deployment of access point base stations within a network environment. As shown in FIG. 4, the system 400 may include one or more femto access points, such as, for example, FAP 410, each being installed in a corresponding small scale network environment 430, such as, for example an enterprise installation or residence. The FAP 410 may be configured to serve one or more access terminals (AT) 420, 422. Each FAP 410 may be further coupled to the Internet 440 and a mobile operator core network 450 via a wired backhaul, for example, a DSL, cable, fiber optic, or T1/T3 line. The environment 430 may include, for example in an enterprise application, one or more relay FAP 412 connected to the FAP 410 via a wired connection, for serving a second access terminal 422. The relay or secondary FAP 412 essentially extends the capability of a primary FAP 410 over a larger area, and may perform a subset of access point functions provided by the FAP 410, or by the combination of the FAP 410 and the relay FAP 412. Together, the combination of the FAP 410 and the relay FAP 412 may be considered to comprise a single FAP distributed over nodes of a local network. It should be appreciated however, that in many implementations a single FAP may serve the environment 430, without using any additional relay or secondary node 412.

Although embodiments described herein use 3GPP2 terminology, it is to be understood that the embodiments may be applied to 3GPP (Re199, Re15, Re16, Re17) technology, as well as 3GPP2 (1×RTT, 1×EV-DO Re10, RevA, RevB) technology and other known and related technologies. In such embodiments described herein, the owner of the FAP 410 subscribes to mobile service, such as, for example, 3G mobile service, offered through the mobile operator core network 450, and the AT 420 is capable to operate both in macro cellular environment and in residential small scale network environment. The FAP 410, 412 and the access terminals 420, 422 may using multiple air interfaces 460, 462. For example, a first air interface 460 may be, or may include, a WWAN interface as used for wireless communication between macro base stations and mobile terminals of the core network 450, for example, an LTE interface. A second air interface 462 may be, or may include, a WLAN or WiMax interface as used between wireless routers and network devices in residential or enterprise settings.

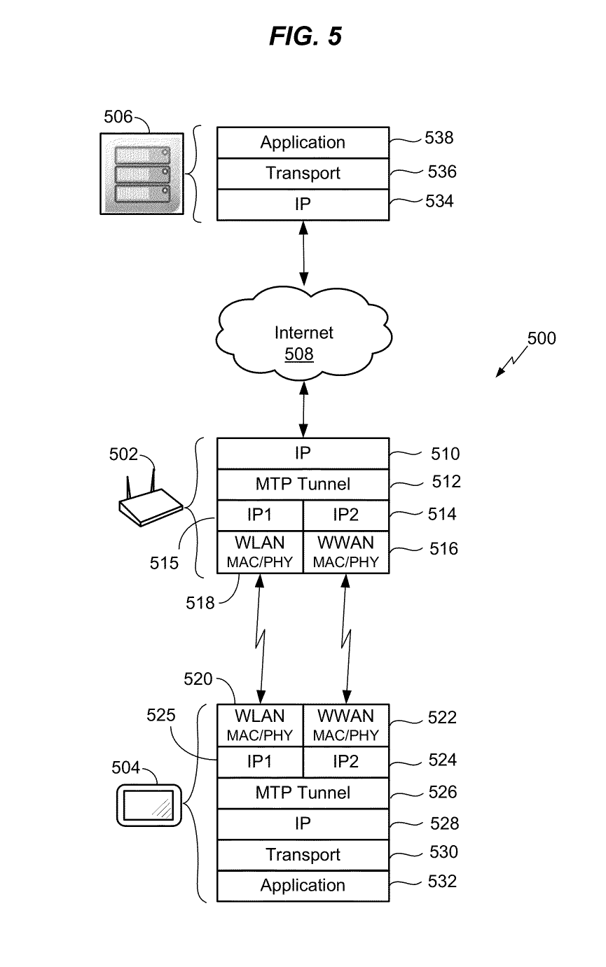

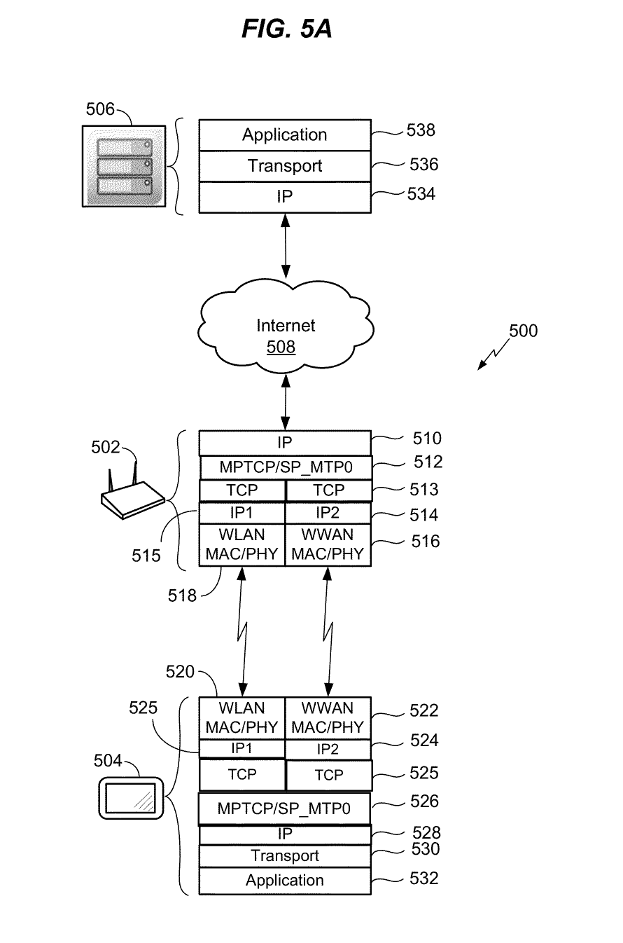

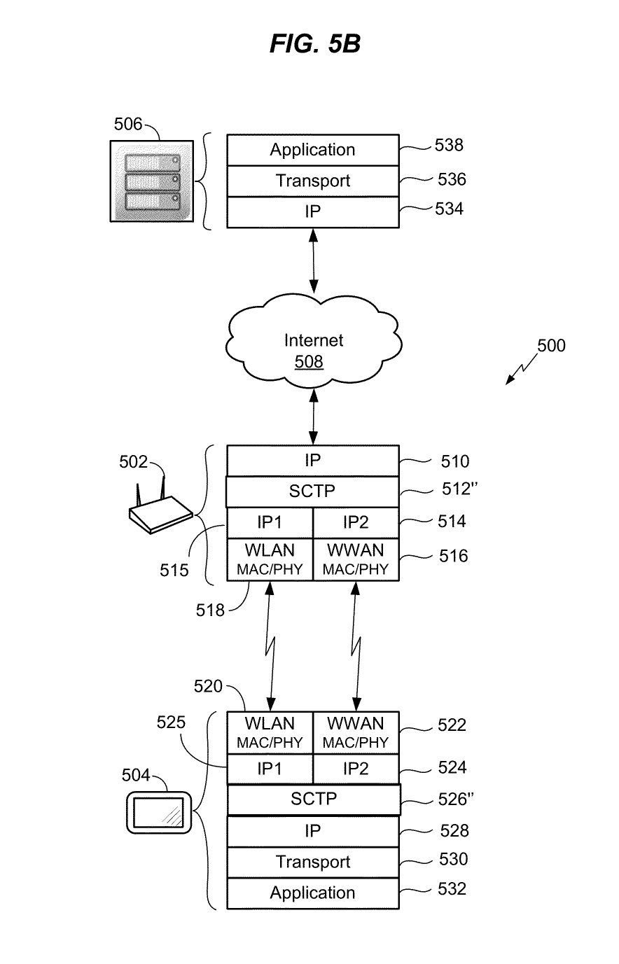

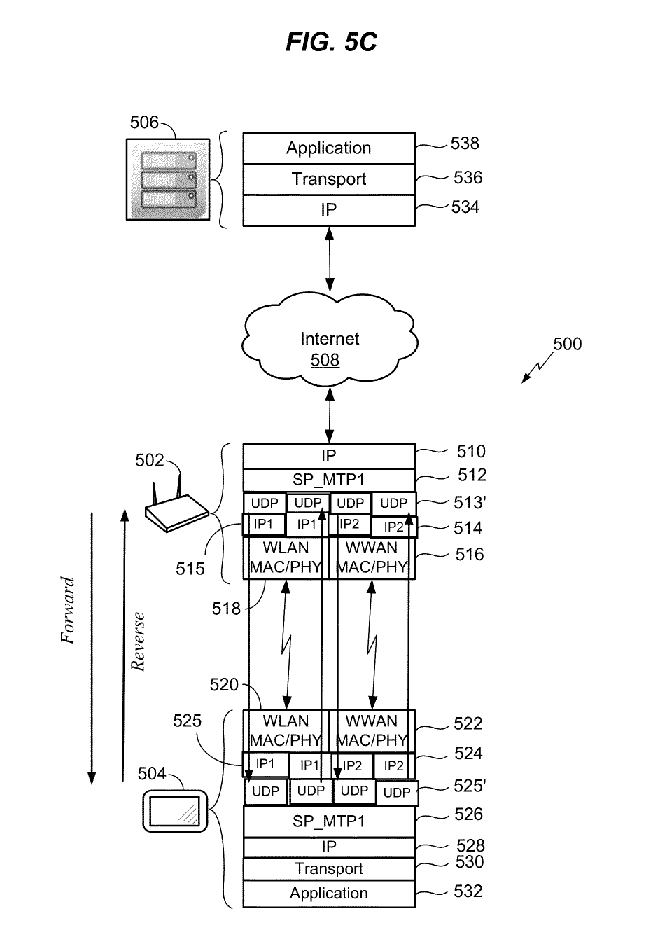

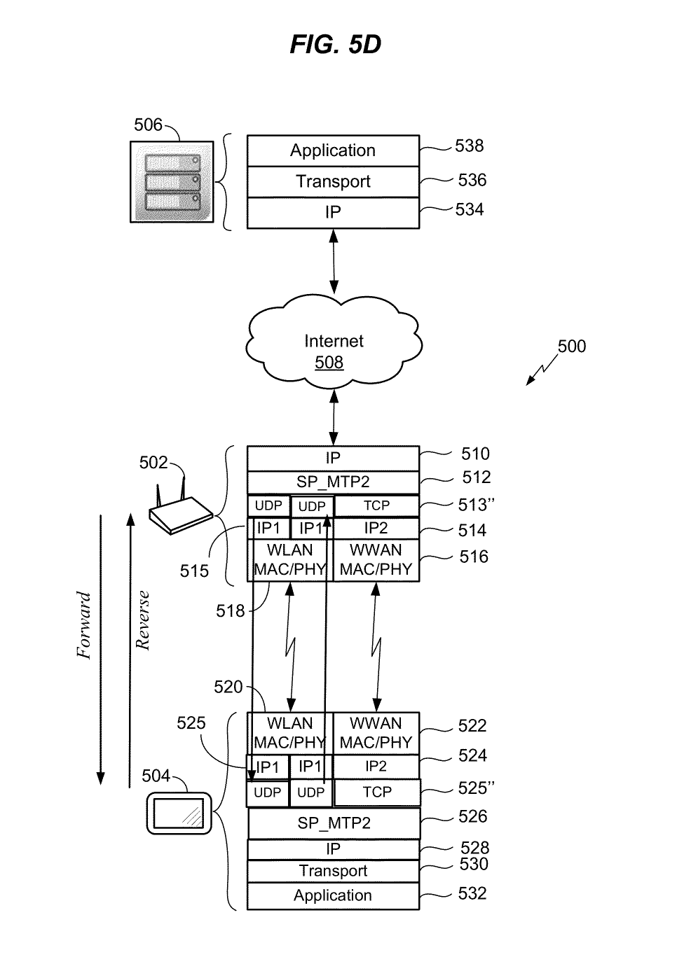

A more detailed example of a dual wireless station system 500 including a femto access point 502 and access terminal 504 both incorporating an MTP tunnel component 512, 526 is shown in FIG. 5. The entirety of the depicted communication chain links an application layer 530 of the access terminal 504 to an application layer 538 of an application server 506. The access terminal 504 and application server 506 may be addressed using respective IP addresses for routing of IP packet data via the Internet 508 through the femto access point 502. The femto access point 502 may also be addressed using an IP address, and may be in communication with the application server 506 and with an operator core network (not shown) via the Internet. Packet data may originate and be received by any IP-addressed component connected to the Internet 508, for example, the application server 508 comprising an application layer 538, a transport layer 536 and an IP layer 534 for generating and receiving data packets using an IP protocol. The transport layer 536 can be TCP or UDP or SCTP or another transport protocol. The femto access point may act as an intermediary device for routing, switching, or relaying packets originating from the access terminal 504 and destined to any destination connected to the Internet 508, or packets originating from any Internet-connected source (e.g., application server 506) to the access terminal 504.

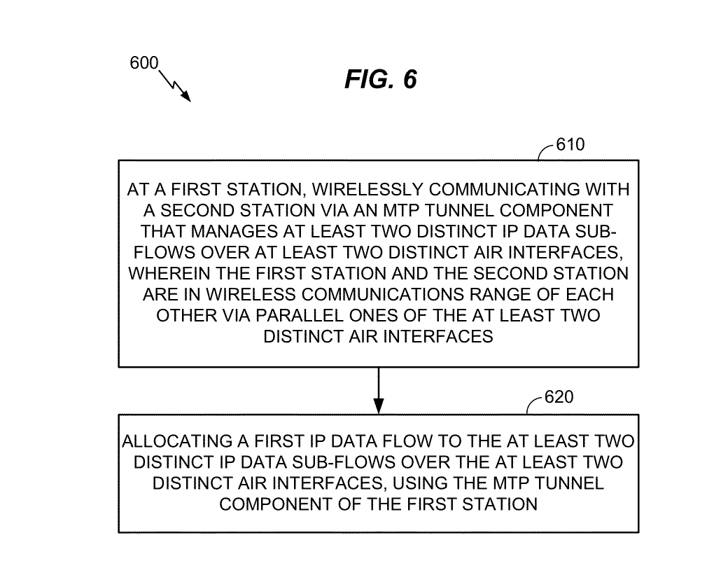

The access terminal may include an application layer 532, for example, a media player application or video game, which downloads data from the application server 506, and may also upload data to the application server. Data passing to and from the application layer 532 may pass through a transport layer 530 and to an IP layer 528, which may be configured conventionally. The transport layer 530 can be TCP or UDP or SCTP or another transport protocol. The access terminal may include an MTP tunnel component mediating between the IP layer 528 and two or more distinct IP layers 514, 515 for respective WLAN air interface 520 and WWAN air interface 522. The distinct air interfaces 520, 522 may include Media Access Control (MAC) and physical (PHY) layers that may be conventionally configured. The MTP tunnel component may initiate (wrap) an IP tunnel for packet data from the application layer 532 destined to an Internet address, terminate (unwrap) an IP tunnel for packet data from the Internet 508 destined to the application layer 532, and perform other functions as described in connection with FIGS. 6-11 below.

Packet data passing through the MAC/PHY layers of the WLAN interface 520 and WWAN interface 522 may be wrapped by the MTP tunnel component 526 and communicated (transmitted/received) to corresponding MAC/PHY layers for the WLAN interface 518 and WWAN interface 516 incorporated in the femto access point 502. From or to the respective MAC layers 518 and 516, packet data passes through the respective distinct IP layers 514 and 515 of the access point 502, to or from an MTP tunnel component 512 embodied in a processor of the access point 502. The MTP component 512 of the access point 502. The MTP tunnel component 512 may initiate (wrap) an IP tunnel for packet data from the IP layer 510 arriving from the Internet 508 and destined to the access terminal 505, terminate (unwrap) an IP tunnel for packet data from the application layer 532 destined to the Internet 508, and perform other functions as described in connection with FIGS. 6-11 below. In an embodiment as shown in FIG. 5a, the MTP tunnel can be based on a standard MultipathTCP protocol managing multiple TCP/IP sub-flows, where one or more TCP/IP sub-flows are used to manage each IP data flow. Alternatively, as shown in FIG. 5a, the MTP tunnel can be based on a special multipath transport protocol (SP_MTP0) managing multiple TCP/IP sub-flows, where one or more TCP/IP sub-flows are used to manage each IP data flow. Alternatively, as shown in FIG. 5b, the MTP tunnel can be implemented based on SCTP (Stream Control Transmission Protocol) managing mutliple IP data flows. In another embodiment as shown in FIG. 5c, the MTP tunnel can be implemented using a special multipath transport protocol SP_MTP1, managing one or more forward and reverse UDP/IP sub-flows for each IP data flow, where the forward UDP/IP sub-flow delivers data, and the reverse UDP/IP sub-flow provides feedback on the data packets received over the forward UDP/IP sub-flow. In another embodiment, as shown in FIG. 5d, the MTP tunnel can be implemented using a special multipath transport protocol that utilizes a combination of TCP/IP and UDP/IP forward and reverse sub-flows.

Each of the protocols MPTCP, SCTP, SP_MTP0, SP_MTP1, and SP_MTP2, can distribute data across the sub-flows based on its awareness of the performance of each wireless link, where the performance can be based on at least one of a transport layer throughput, a MAC layer throughput, a physical layer throughput, a packet error rate, or a physical layer modulation and coding scheme. In addition, the MTP tunnel can select between concurrent aggregation and robust modes of operation. A concurrent aggregation mode actively utilizes multiple wireless links to aggregate performance across the links. Alternatively, a robust mode of operation can select the best link to utilize based on the dynamic nature of the wireless link performance. For example, a WLAN link may get loaded with other traffic in the same home/enterprise, whereas the WWAN link may be lightly loaded, or alternatively the WLAN link may be lightly loaded, whereas the WWAN link may be highly loaded based on other traffic due to WWAN modems on other devices communicating with the WWAN, or alternatively either wireless link (WLAN or WWAN) may suffer a transient failure, during which another wireless link (WWAN or WLAN respectively) may be used solely until the link suffering transient failure recovers.

In further related aspects, wireless system 500 may include receiving the first IP data flow using a single IP address of the network and splitting the received IP data flow into the at least first IP sub-flow carried on the first air interface and into the at least second IP sub-flow carried on a second air interface. Additionally, wireless system 500 may be configured to receive at least first IP sub-flow received on the first air interface and receive the at least second IP sub-flow received on the second air interface, merging the received sub-flows into the first IP data flow, and communicating the first IP data flow to the IP network using a single IP address of the network.

Still further, wireless system 500 may include splitting the first IP data flow associated with an application into the at least first IP sub-flow carried on the first air interface and into the at least second IP sub-flow carried on a second air interface. In the alternative, the at least first IP sub-flow received on the first air interface and the at least second IP sub-flow received on the second air interface may be merged into the first IP data flow associated with an application.

Traditionally, in the wireless communication system 500, retransmissions on a first IP sub-flow are performed on the same sub-flow as in TCP/IP but optionally the information associated with a first sub-flow may be configured to be retransmitted on an alternate IP sub-flow. This feature of utilizing alternate sub-flows assists in retransmission in the wireless communication system 500. Note, the alternate sub-flows may be configured as TCP/IP sub-flow or UDP/IP sub-flow. In essence, this should assist the first sub-flow in making progress through the communication link when the communication link is congested or if the wireless link conditions have deteriorated.

In view of exemplary systems shown and described herein, methodologies that may be implemented in accordance with the disclosed subject matter, will be better appreciated with reference to various flow charts. For purposes of simplicity of explanation, methodologies are shown and described as a series of acts/blocks, but the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component) using at least one communications device to perform information processing operations. Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram. Any described information processing operations may be performed using an information processing device such as a computer processor, operating on machine-encoded signals. Such operations are not intended to be implemented in the abstract, and are not expected to have utility unless performed by an information processing machine suitably configured for use in one or more wireless communications networks to process signals from communications devices operating in such networks.

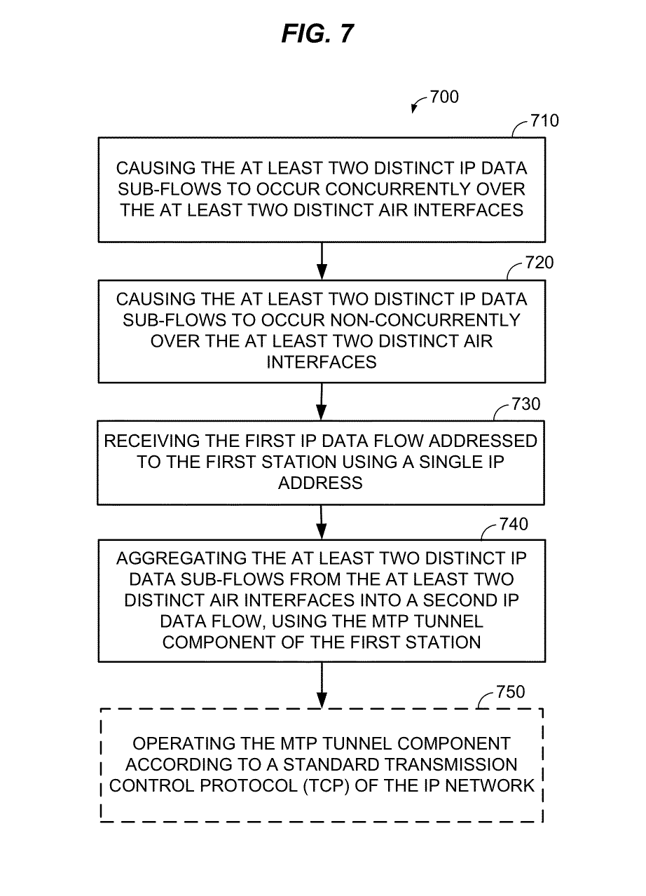

With reference to the foregoing figures and description, a method 600 for communicating between wireless stations using an MTP tunnel component may include steps and operations as shown in FIG. 6. The method 600 may encompass certain additional aspects or operations of method 600 as discussed below in connection with FIGS. 7-12. The method 600 may include, at 610, at a first station, wirelessly communicating with a second station via an MTP tunnel component that manages at least two distinct IP data sub-flows over at least two distinct air interfaces. The first station and the second station may be in wireless communications range of each other via parallel ones of the at least two distinct air interfaces. Accordingly, tunneled packet data may be transmitted from the first station and wirelessly received by the second station over the at least two air interfaces, without traversing any intervening wired or wireless link. In addition, the method may include, at 620, allocating a first IP data flow to the at least two distinct IP data sub-flows over the at least two distinct air interfaces, using the MTP tunnel component of the first station. Allocating may include determining one or more of the distinct air interfaces over which certain packet data will be transmitted, in response to some condition or parameter related to relative condition of the air interface links, or some other network condition. Note, the two distinct IP data sub-flows may be configured to utilize different wireless communication channels for transporting data and may be configured to utilize the same wireless communication channel for transporting data.

Also note, that the method of claim 600 is performed in a femto-cell or a WiFI access point, or in an integrated system comprising a femto-cell capability and an WiFi access point capability.

More detailed aspects of method 600 are described below in connection with FIGS. 7-11, which show further optional operations or aspects 700, 800, 900, 1000 and 1100 that may be performed by the wireless station in conjunction with the method 600. The operations shown in FIGS. 7-11 are not required to perform the method 600. These operations may be independently performed and are not mutually exclusive. Therefore any one of such operations may be performed regardless of whether another downstream or upstream operation is performed. If the method 600 includes at least one operation of FIGS. 7-11, then the method 600 may terminate after the at least one operation, without necessarily having to include any subsequent downstream operation(s) that may be illustrated.

In an aspect, the method 600 may include the additional operations 700 as shown in FIG. 7. The method 600 may further include, at 710, causing the at least two distinct IP data sub-flows to occur concurrently over the at least two distinct air interfaces. For example, the MTP tunnel component may allocate alternating sets of tunnel packets to each of the distinct air interfaces, causing concurrent transmission of tunnel data to occur at the physical layer. In the alternative, or in addition, the method 600 may further include, at 720, causing the at least two distinct IP data sub-flows to occur non-concurrently over the at least two distinct air interfaces. For example, the MTP tunnel component may allocate a first group of tunneled packet data solely to a first air interface, and then wait until transmission of the first group of data has been completed before allocating any tunnel data to a second air interface. Note, the MTP tunnel originates on a first station and terminates on a second station.

In another aspect, the method 600 may include, at 730, receiving the first IP data flow addressed to the first station using a single IP address. The MTP tunnel component may enable packet flow over two or more air interfaces to the access terminal. The use of a single IP address on incoming packet data is consistent with this new capability. Neither the application server nor the application layer of the end user terminal need be aware of the existence or operation of the tunnel component. Accordingly, incoming packets may be addressed using a single IP address for the intended destination.

A converse operation to allocating data using the MTP tunnel component may include aggregating data that the MTP tunnel component receives over the multiple air interfaces. To handle both uplink and downlink data flows, the method 600 may further include, at 740, aggregating the at least two distinct IP data sub-flows from the at least two distinct air interfaces into a second IP data flow, using the MTP tunnel component of the first station. Note, the second IP data flow is communicated over an MTP tunnel between the stations using at least two distinct sub-flows over two distinct air interfaces, where the MTP tunnel originates on the first station and terminates on the second station. In addition, the MTP tunnel maintains end-to-end connectivity between the two stations over at least one air-interface during transient failure of wireless connectivity over other air-interfaces.

It should be appreciated that allocation of data may be considered as an aspect of initiating (wrapping) a packet data tunnel over a multiple transport paths, while aggregating the data may be considered as an aspect of terminating (unwrapping) a packet data tunnel over multiple transport paths. Other aspects of initiating and terminating the multi-path tunnel may be adapted from any suitable tunneling protocol as known in the art for a layered protocol model such as, for example, Transmission Control Protocol/Internet Protocol (TCP/IP). A suitable tunneling protocol for adapting to the present multi-path tunnel applications may include, for example, Layer 2 Tunneling Protocol (L2TP), which runs over the transport layer using User Datagram Protocol (UDP) over IP. Suitable tunneling protocols may include SSL-based tunneling protocols such as OpenVPN, as used in Virtual Private Networks (VPN) or other applications. Data encryption at the multipath transport tunnel layer can be optional while utilizing the tunneling feature of the protocol. Thus the multi-path tunnel may be implemented without encryption where the underlying packet data is already encrypted and/or the requirements for securing the data transmitted over the multiple air interfaces are not high.

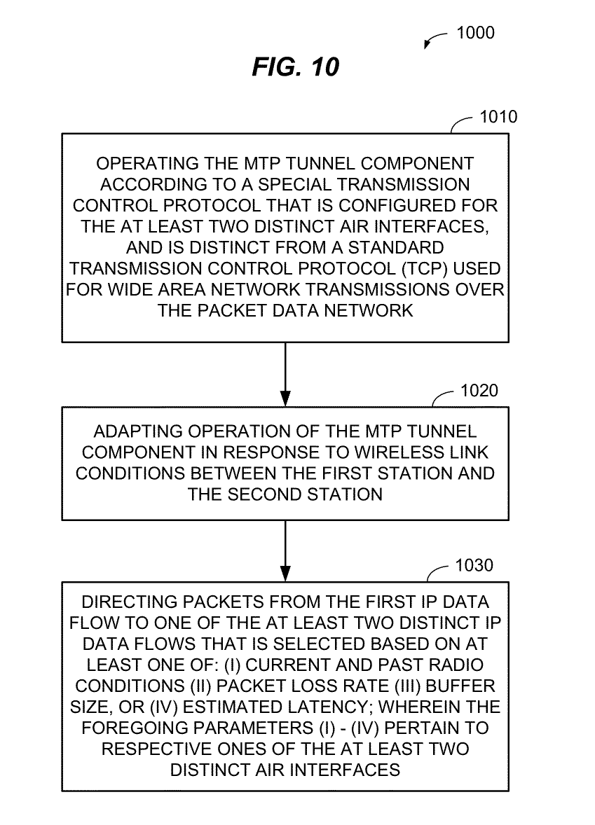

In a related aspect, the method 600 may further include, at 750, operating the MTP tunnel component according to a standard TCP of the IP network. However, TCP is in general developed for wide area networks sometimes spanning long distances and involving considerable lag time between dispatch and receipt of packet data. Accordingly, standard TCP may not be optimized for direct air links between devices in wireless proximity, especially when the distance spanned by the air links is relatively short such as, for example, in an enterprise or residential femtocell application. Accordingly, for such applications, use of a non-standard or special version of TCP may be advantageous, as described in more detail below in connection with FIG. 10.

In some embodiments, the MTP tunnel component may be implemented in an application terminal. Accordingly, the method 600 may include the additional operations and aspects 800, as shown in FIG. 8. The method 600 may include, at 810, mediating IP packet data between a network layer for an application layer and respective network layers for each of the at least two distinct air interfaces, using the MTP tunnel component. As used herein, mediating means handling data that is in an intermediate position between two topological referents of the network (e.g., between the application layer and the respective network layers for each of the at least two distinct air interfaces). This use of the MTP component is illustrated in FIG. 5, where the MTP tunnel component 526 mediates between the application layer 532 and the respective network layers 524, 525. In this aspect, the first station may be, or may include, an access terminal operating an application that uses the packet data handled by the MTP tunnel component, and the method 600 may include, at 820, the MTP tunnel component mediating between the at least two distinct air interfaces 520, 522 and the application layer 532.

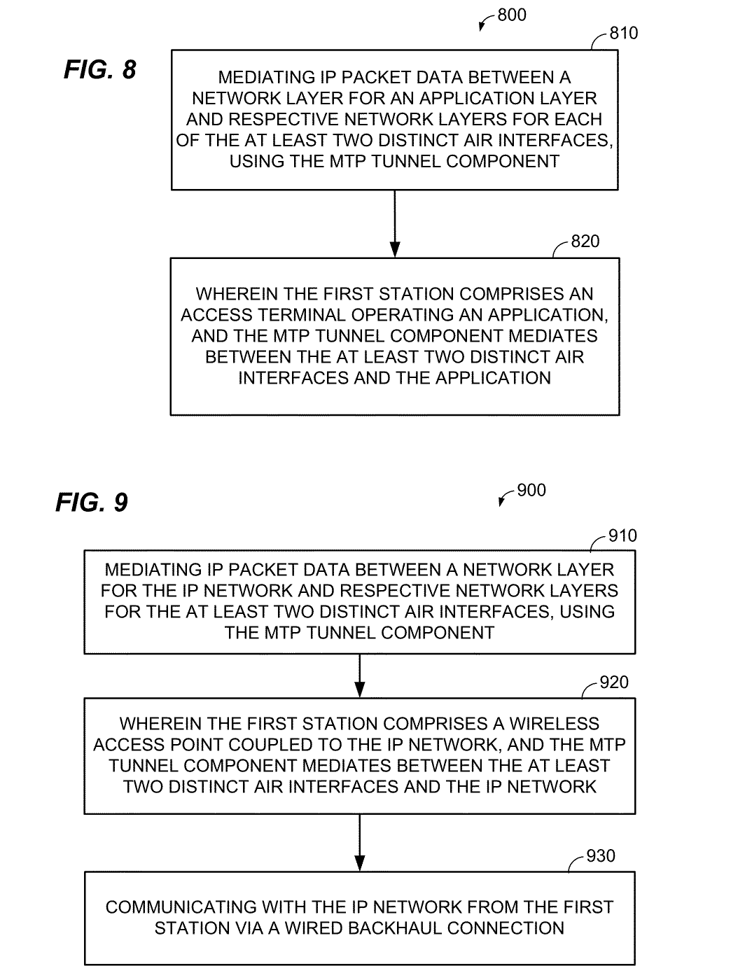

In some embodiments, the MTP tunnel component may be implemented in an access point, for example, a femtocell. Accordingly, the method 600 may include the additional operations 900, as shown in FIG. 9. The method 600 may include, at 910, mediating IP packet data between a network layer for the IP network and respective network layers for the at least two distinct air interfaces, using the MTP tunnel component. This use of the MTP component is illustrated in FIG. 5, where the MTP tunnel component 512 mediates between the IP layer 510 and the respective network layers 514, 515. In this aspect, the first station may be, or may include, an access point coupled to the IP network, and the method 600 may include, at 920, the MTP tunnel component mediating between the at least two distinct air interfaces 515, 516 and the IP network layer 510. The method 600 may further include, at 930, communicating with the IP network from the first station via a wired backhaul connection. For example, a FAP may use a wired backhaul to communicate with an application server over the Internet, or with an operator core network. Use of a wired backhaul may provide the advantage of higher data rates through the MTP tunnel component and enable greater use of additional bandwidth provided by the multiple air interfaces. However, the technology may be used with or without a wired connection for accessing an IP network.

As mentioned above, tunneling over multiple air interfaces may benefit from application of a non-standard tunneling protocol in the MTP tunnel component. Accordingly, the method may include one or more operations 1000 as shown in FIG. 10, illustrating examples of operations that may be performed by a special tunneling protocol adapted or optimized for a multi-path tunnel over multiple direct air links to a receiving station. In general, the method 600 may include, at 1010, operating the MTP tunnel component according to a special transmission control protocol that is configured for the at least two distinct air interfaces, and is distinct from a standard TCP used for wide area network transmissions over the IP network. For example, the method 600 may include, at 1020, adapting operation of the MTP tunnel component in response to wireless link conditions between the first station and the second station. For example, the tunnel component may allocate tunnel packets more heavily, or entirely, based on a determination of current conditions on each wireless link, or may determine a congestion window size based on wireless link performance. Current performance or condition of each air interface link may be readily assessed by the tunnel component, which may be coupled directly to the MAC/PHY layers for the air interfaces via an intervening IP layer. Hence, the MTP tunnel component should not require explicit feedback using overlay applications or additional UDP or TCP sub-flows to receive feedback about pertinent channel conditions. For more specific example of adaptive data allocation by an MTP tunnel component, the method 600 may include, at 1030, directing packets from the first IP data flow to one of the at least two distinct IP data sub-flows that is selected based on at least one of: (i) current and past radio conditions (ii) packet loss rate (iii) buffer size, or (iv) estimated latency. In the foregoing more specific examples, the parameters referenced by the numerals (i)-(iv) should be understood as pertaining to respective ones of the at least two distinct air interfaces, and should be adapted to enable comparison of corresponding conditions across distinct air interfaces, for example, WWAN, WLAN, LTE, HSPA, or WiMAX links.

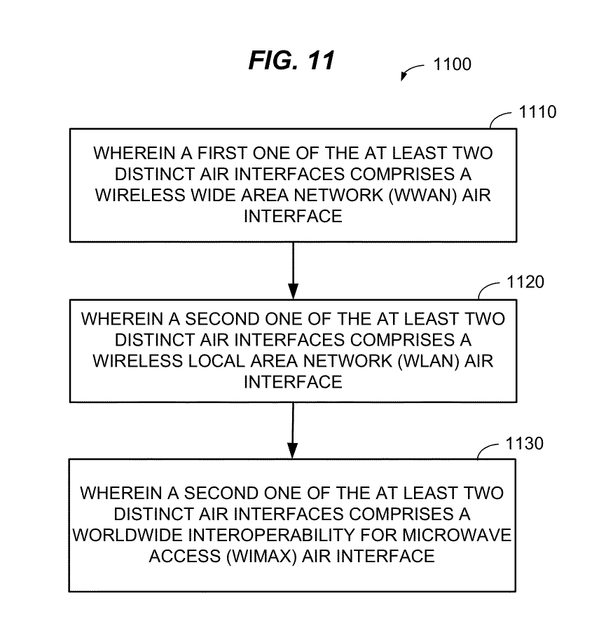

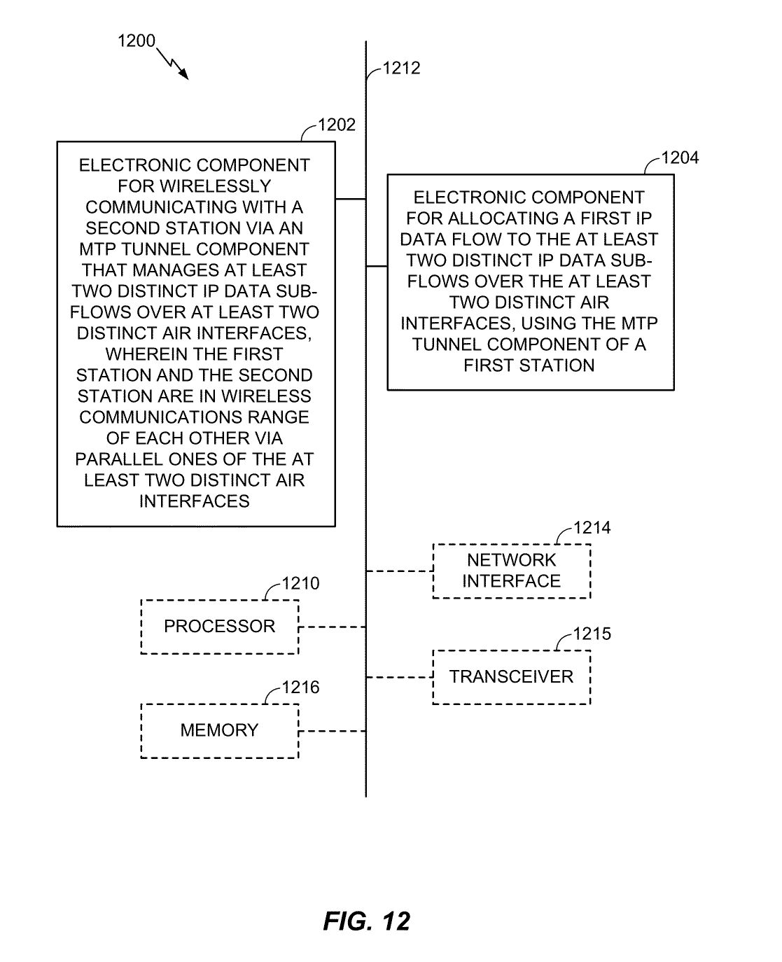

The method 600 may be characterized by more detailed aspects or operations 1100, as shown in FIG. 11. For example, as indicated at 1110, a first one of the at least two distinct air interfaces may be, or may include, a WWAN air interface. For example, one or more of the air interfaces may include an LTE, LTE Advanced (LTE-A), or even HSPA interfaces. In such case the method 600 may include communicating (e.g., transmitting and/or receiving) one or more of the at least two distinct IP data sub-flows over the WWAN interface, using the first station. For further example, as indicated at 1120, a second one of the at least two distinct air interfaces may be, or may include, a WLAN air interface. For example, one or more of the air interfaces may include a WLAN interface based on IEEE 802.11 standards, sometimes referred to as “Wi-Fi.” Wi-Fi is a local area network solution designed to add wireless connectivity to wired LANs, and may be typically employed with private LANs in a residential or enterprise setting. Wi-Fi may support a wireless range between stations up to a maximum of a few hundred meters, or longer if relay nodes are included. The standards for WLAN technologies includes: the 802.11a standard that uses the same data link layer protocol and frame format as the original standard, but an OFDM based air interface (physical layer). It operates in the 5 GHz band with a maximum net data rate of 54 Mbit/s, plus error correction code, which yields realistic net achievable throughput in the mid-20 Mbit/s. The 802.11b WLAN standard has a maximum raw data rate of 11 Mbit/s and uses the same media access method defined in the original standard. The 802.11g standard works in the 2.4 GHz band (like 802.11b), but uses the same OFDM based transmission scheme as 802.11a. This standard operates at a maximum physical layer bit rate of 54 Mbit/s exclusive of forward error correction codes, or about 22 Mbit/s average throughput. Last, the 802.11n standard improves upon the previous 802.11 standards by adding multiple-input multiple-output antennas. 802.11n operates on both the 2.4 GHz and the lesser used 5 GHz bands. Consequently, for WLAN applications, the method 600 may include communicating one or more of the at least two distinct IP data sub-flows over the WLAN interface, using the first station.

In the alternative or in addition, as indicated at 1130, a second one of the at least two distinct air interfaces may be, or may include, a Worldwide Interoperability for Microwave Access (WiMAX) air interface. For example, one or more of the air interfaces may be based on IEEE 802.16 standards. WiMAX is a metro area solution designed to deliver broadband service over a larger public (e.g., metro) area. WiMAX may provide a wireless range between stations up to a maximum of about 30 miles. WiMAX may resemble Wi-Fi in that both provide an air interface for aggregating access to a wired IP backhaul, but differs in being designed for higher-power base stations, such as eNBs, for servicing a larger number of access terminal over a larger area. A wireless station including distinct WWAN and WiMAX air interfaces and tunneling data over these distinct interfaces may therefore be implemented at a higher power, larger scale station than is generally contemplated for femtocell applications. Such a higher power station (e.g., an eNB) may not include a WLAN interface. In comparison, a femtocell node including an MTP tunneling component may include WWAN and WLAN interfaces, and not a WiMAx interface.

Note, Home Node B (HNB) is connected to an existing residential broadband service such that an HNB provides 3G radio coverage for 3G handsets within a home. HNBs incorporate the capabilities of a standard node B as well as the radio resource management functions of a standard Radio Network Controller. Additionally, Home eNode B (HeNB) is connected to an existing residential broadband service, an HeNB provides LTE radio coverage for LTE handsets within a home. HeNBs incorporate the capabilities of a standard eNodeB.

With reference to FIG. 12, there is provided an example of a apparatus 1200 that may be configured as a wireless station in a wireless network, or as a processor or similar device for use within the wireless station, for example as a femto access point or access terminal The apparatus 1200 may include functional blocks that can represent functions implemented by a processor, software, or combination thereof (e. g., firmware).

As illustrated, in one embodiment, the apparatus 1200 may include an electrical component or module 1202 for wirelessly communicating with a second station via MTP tunnel component that manages at least two distinct IP data sub-flows over at least two distinct air interfaces, wherein the first station and the second station are in wireless communications range of each other via parallel ones of the at least two distinct air interfaces. For example, the electrical component 1202 may include at least one control processor coupled to a transceiver or the like, to one of a network interface or application layer, and to a memory with instructions for managing the at least two distinct IP data sub-flows in a tunneling mode. The apparatus 1200 may also include an electrical component 1204 for allocating a first IP data flow to the at least two distinct IP data sub-flows over the at least two distinct air interfaces, using the MTP tunnel component of the first station. For example, the electrical component 1204 may include at least one control processor coupled to a transceiver or the like and to a memory holding instructions for allocating packet data to the different air interfaces based on one or more control parameters. The apparatus 1200 may include similar electrical components for performing any or all of the additional operations 700-1100 described in connection with FIGS. 7-11, which for illustrative simplicity are not shown in FIG. 12.

In related aspects, the apparatus 1200 may optionally include a processor component 1210 having at least one processor, in the case of the apparatus 1200 configured as a mobile entity. The processor 1210, in such case, may be in operative communication with the components 1202-1204 or similar components via a bus 1212 or similar communication coupling. The processor 1210 may effect initiation and scheduling of the processes or functions performed by electrical components 1202-1204. The processor 1210 may encompass the components 1202-1204, in whole or in part. In the alternative, the processor 1210 may be separate from the components 1202-1204, which may include one or more separate processors.

In further related aspects, the apparatus 1200 may include a network interface, for example a TCP/IP interface for connecting to a wired or wireless backhaul or for connecting to a femto access point, eNB, or the like. In addition, the apparatus 1200 may include a radio transceiver component 1215. A stand alone receiver and/or stand alone transmitter may be used in lieu of or in conjunction with the transceiver 1215. In the alternative, or in addition, the apparatus 1200 may include multiple transceivers or transmitter/receiver pairs, which may be used to transmit and receive on different carriers. The apparatus 1200 may optionally include a component for storing information, such as, for example, a memory device/component 1216. The computer readable medium or the memory component 1216 may be operatively coupled to the other components of the apparatus 1200 via the bus 1212 or the like. The memory component 1216 may be adapted to store computer readable instructions and data for performing the activity of the components 1202-1204, and subcomponents thereof, or the processor 1210, the additional aspects 700, 800, 900, 1000 or 1100, or the methods disclosed herein. The memory component 1216 may retain instructions for executing functions associated with the components 1202-1204. While shown as being external to the memory 1216, it is to be understood that the components 1202-1204 can exist within the memory 1216.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any non-transient tangible medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication between stations addressable via an Internet Protocol (IP) network, comprising:
at a first station, wirelessly communicating with a second station via a multi-path transport protocol (MTP) tunnel component that manages at least a first IP data sub-flow over a first air interface and at least a second IP data sub-flow over a second air interface, wherein the first station and the second station are in wireless communications range of each other via parallel ones of the at least two distinct air interfaces; and
allocating a first IP data flow to the at least two distinct IP data sub-flows over the at least two distinct air interfaces, using the MTP tunnel component of the first station.

2. A method of claim 1, wherein the first IP data sub-flow over the first air interface or a third IP data sub-flow over the first air interface is a TCP/IP sub-flow managed by the MTP tunnel.

3. A method of claim 1, wherein the second IP data sub-flow over the second air interface or a fourth IP data sub-flow over the second air interface is a TCP/IP sub-flow managed by the MTP tunnel.

4. A method of claim 1, wherein the first IP data sub-flow over the first air interface or a third IP data sub-flow over the first air interface is a UDP/IP sub-flow managed by the MTP tunnel.

5. A method of claim 1, wherein the second IP data sub-flow over the second air interface or a fourth IP data sub-flow over the second air interface is a UDP/IP sub-flow managed by the MTP tunnel.

6. The method of claim 1, wherein allocating the first IP data flow is managed to cause the at least two distinct IP data sub-flows to occur concurrently over the at least two distinct air interfaces.

7. The method of claim 1, wherein allocating the first IP data flow is managed to cause the at least two distinct IP data sub-flows to occur sequentially over the at least two distinct air interfaces.

8. The method of claim 1, further comprising aggregating the at least two distinct IP data sub-flows from the at least two distinct air interfaces into a second IP data flow, using the MTP tunnel component of the first station.

9. The method of claim 1, further comprising receiving the first IP data flow using a single IP address of a network and splitting the received IP data flow into the at least first IP sub-flow carried on the first air interface and into the at least second IP sub-flow carried on a second air interface.

10. The method of claim 1, further comprising receiving the at least first IP sub-flow received on the first air interface and receiving the at least second IP sub-flow received on the second air interface, merging the received sub-flows into the first IP data flow, and communicating the first IP data flow to the IP network using a single IP address of a network.

11. The method of claim 1, further comprising splitting the first IP data flow associated with an application into the at least first IP sub-flow carried on the first air interface and into the at least second IP sub-flow carried on a second air interface.

12. The method of claim 1, further comprising merging into the first IP data flow associated with an application, the at least first IP sub-flow received on the first air interface and the at least second IP sub-flow received on the second air interface.

13. The method of claim 1, further comprising mediating IP packet data between a network layer for an application layer and respective network layers for each of the at least two distinct air interfaces, using the MTP tunnel.

14. The method of claim 1, wherein the first station comprises an access terminal operating an application, and the MTP tunnel component mediates between the at least two distinct air interfaces and the application.

15. The method of claim 1, further comprising mediating IP packet data between a network layer for the IP network and respective network layers for the at least two distinct air interfaces, using the MTP tunnel.

16. The method of claim 1, wherein the first station comprises a wireless access point coupled to the IP network, and the MTP tunnel component mediates between the at least two distinct air interfaces and the IP network.

17. The method of claim 1, further comprising communicating with the IP network from the first station via a wired backhaul connection.

18. The method of claim 1, further comprising operating the MTP tunnel component according to a standard Multipath Transmission Control Protocol (MPTCP) of the IP network or a standard Stream Control Transmission Protocol (SCTP) of the IP network.

19. The method of claim 1, further comprising operating the MTP tunnel component according to a special transmission control protocol that is configured for the at least two distinct air interfaces, and is distinct from a standard Multipath Transmission Control Protocol (MPTCP) used for wide area network transmissions over the packet data network.

20. The method of claim 19, further comprising adapting operation of the MTP tunnel component in response to wireless link conditions between the first station and the second station.

21. The method of claim 19, wherein the special multipath transport protocol delivers data on a IP data flow using a TCP/IP sub-flow.

22. The method of claim 19, wherein the special multipath transport protocol delivers data on an IP data flow adapting to the available performance of the wireless link for said IP data flow.

23. The method of claim 22, wherein the available performance of the wireless link is determined based on at least one of transport-layer throughput, MAC-layer throughput, physical layer throughput, physical layer modulation and coding scheme, and packet error rate.

24. The method of claim 19, wherein the special multipath transport protocol delivers data on an IP data flow using a UDP forward sub-flow over a wireless link.

25. The method of claim 19, wherein the special multipath transport protocol receives information on data delivered on an IP data flow using a UDP reverse sub-flow over a wireless link.

26. The method of claim 20, wherein the special multipath transport protocol creates redundant packets to increase reliability of transmission.

27. The method of claim 26, wherein the redundant packets are created using reed-solomon codes or raptor codes.

28. The method of claim 20, further comprising directing packets from the first IP data flow to one of the at least two distinct IP data sub-flows that is selected based on at least one of: (i) current and past radio conditions (ii) packet loss rate (iii) buffer size, or (iv) estimated latency; wherein the foregoing parameters (i)-(iv) pertain to respective ones of the at least two distinct air interfaces.

29. The method of claim 1, wherein a first one of the at least two distinct air interfaces comprises one of a Wireless Wide Area Network (WWAN) air interface or a Wireless Local Area Network (WLAN) air interface.

30. The method of claim 29, wherein a second one of the at least two distinct air interfaces comprises one of a Wireless Local Area Network (WLAN) air interface or a Wireless Wide Area Network (WWAN) air interface.

31. The method of claim 1, further comprising operating the at least two distinct air interfaces in distinct portions of a radio spectrum, wherein the at least two air interfaces comprise a Wireless Wide Area Network (WWAN) air interface and a Wireless Local Area Network (WLAN) air interface.

32. The method of claim 1, further comprising dynamically selecting between concurrent aggregation and robust modes of operation for the first IP data flow over the at least two distinct air interfaces.

33. The method of claim 1, wherein information associated with a first sub-flow is retransmitted on an alternate sub-flow.

34. The method of claim 1, wherein at least two distinct sub-flows can utilize different wireless communication channels for transporting data.

35. The method of claim 1, wherein at least two distinct sub-flows can utilize the same wireless communication channel for transporting data.

36. The method of claim 1, wherein the method is performed in a femto-cell or a WiFI access point, or in an integrated system comprising a femto-cell capability and an WiFi access point capability.

37. The method of claim 1, wherein a second IP data flow is communicated over an MTP tunnel component between the stations using at least two distinct sub-flows over two distinct air interfaces.

38. The method of claim 1, wherein the MTP tunnel component originates on the first station and terminates on the second station.

39. The method of claim 1, wherein the MTP tunnel maintains end-to-end connectivity between the stations over at least one air-interface during transient failure of wireless connectivity over other air-interfaces.

40. An apparatus for wireless communication between stations addressable via an Internet Protocol (IP) network, comprising:
at a first station, means for wirelessly communicating with a second station via a multi-path transport protocol (MTP) tunnel component that manages at least two distinct IP data sub-flows over at least two distinct air interfaces, wherein the first station and the second station are in wireless communications range of each other via parallel ones of the at least two distinct air interfaces; and
means for allocating a first IP data flow to the at least two distinct IP data sub-flows over the at least two distinct air interfaces, using the MTP tunnel component of the first station.

41. An apparatus for wireless communication between stations addressable via an Internet Protocol (IP) network, comprising: at least one processor configured to: at a first station, communicate wirelessly with a second station via a multi-path transport protocol (MTP) tunnel component that manages at least two distinct IP data sub-flows over at least two distinct air interfaces, wherein the first station and the second station are in wireless communications range of each other via parallel ones of the at least two distinct air interfaces; and allocate a first IP data flow to the at least two distinct IP data sub-flows over the at least two distinct air interfaces, using the MTP tunnel component of the first station; and
a memory coupled to the at least one processor for storing data.

42. The apparatus of claim 41, wherein the first IP data sub-flow over the first air interface or a third IP data sub-flow over the first air interface is a TCP/IP sub-flow managed by the MTP tunnel component.

43. The apparatus of claim 41, wherein the second IP data sub-flow over the second air interface or a fourth IP data sub-flow over the second air interface is a TCP/IP sub-flow managed by the MTP tunnel component.

44. The apparatus of claim 41, wherein the first IP data sub-flow over the first air interface or a third IP data sub-flow over the first air interface is a UDP/IP sub-flow managed by the MTP tunnel component.

45. The apparatus of claim 41, wherein the second IP data sub-flow over the second air interface or a fourth IP data sub-flow over the second air interface is a UDP/IP sub-flow managed by the MTP tunnel component.

46. The apparatus of claim 41, wherein allocating the first IP data flow is managed to cause the at least two distinct IP data sub-flows to occur concurrently over the at least two distinct air interfaces.

47. The apparatus of claim 41, wherein allocating the first IP data flow is managed to cause the at least two distinct IP data sub-flows to occur sequentially over the at least two distinct air interfaces.

48. The apparatus of claim 41, further configured to aggregate the at least two distinct IP data sub-flows from the at least two distinct air interfaces into a second IP data flow, using the MTP tunnel component of the first station.

49. The apparatus of claim 41, further configured to receive the first IP data flow using a single IP address of a network and splitting the received IP data flow into the at least first IP sub-flow carried on the first air interface and into the at least second IP sub-flow carried on a second air interface.

50. The apparatus of claim 41, further configured to receive the at least first IP sub-flow received on the first air interface and receiving the at least second IP sub-flow received on the second air interface, merging the received sub-flows into the first IP data flow, and communicating the first IP data flow to the IP network using a single IP address of the network.

51. The apparatus of claim 41, further configured to split the first IP data flow associated with an application into the at least first IP sub-flow carried on the first air interface and into the at least second IP sub-flow carried on a second air interface.

52. The apparatus of claim 41, further configured to merge into the first IP data flow associated with an application, the at least first IP sub-flow received on the first air interface and the at least second IP sub-flow received on the second air interface.

53. The apparatus of claim 41, further configured to mediate IP packet data between a network layer for an application layer and respective network layers for each of the at least two distinct air interfaces, using the MTP tunnel component.

54. The apparatus of claim 41, wherein the first station comprises an access terminal operating an application, and the MTP tunnel component mediates between the at least two distinct air interfaces and the application.

55. The apparatus of claim 41, further configured to mediate IP packet data between a network layer for the IP network and respective network layers for the at least two distinct air interfaces, using the MTP tunnel component.

56. The apparatus of claim 41, wherein the first station comprises a wireless access point coupled to the IP network, and the MTP tunnel component mediates between the at least two distinct air interfaces and the IP network.

57. The apparatus of claim 41, further configured to communicate with the IP network from the first station via a wired backhaul connection.

58. The apparatus of claim 41, further configured to operate the MTP tunnel component according to a standard Multipath Transmission Control Protocol (MPTCP) of the IP network or a standard Stream Control Transmission Protocol (SCTP) of the IP network.

59. The apparatus of claim 41, further configured to operate the MTP tunnel component according to a special transmission control protocol that is configured for the at least two distinct air interfaces, and is distinct from a standard Multipath Transmission Control Protocol (MPTCP) used for wide area network transmissions over the packet data network.

60. The apparatus of claim 59, further configured to adapt operation of the MTP tunnel component in response to wireless link conditions between the first station and the second station.

61. The apparatus of claim 59, wherein the special multipath transport protocol delivers data on a IP data flow using a standard TCP sub-flow over the wireless link for said IP data flow.

62. The apparatus of claim 59, wherein the multipath transport protocol delivers data on an IP data flow adapting to the available performance of the wireless link for said IP data flow.

63. The apparatus of claim 62, wherein the available performance of the wireless link is determined based on at least one of transport-layer throughput, MAC-layer throughput, physical layer throughput, physical layer modulation and coding scheme, and the packet error rate.

64. The apparatus of claim 59, wherein the special multipath transport protocol delivers data on an IP data flow using a UDP forward sub-flow over a wireless link.

65. The apparatus of claim 59, wherein the special multipath transport protocol receives information on data delivered on an IP data flow using a UDP reverse sub-flow over a wireless link.

66. The apparatus of claim 60, wherein the special multipath transport protocol creates redundant packets to increase reliability of transmission.

67. The apparatus of claim 66, wherein the redundant packets are created using reed-solomon codes or raptor codes.

68. The apparatus of claim 60, further configured to direct packets from the first IP data flow to one of the at least two distinct IP data sub-flows that is selected based on at least one of: (i) current and past radio conditions (ii) packet loss rate (iii) buffer size, or (iv) estimated latency; wherein the foregoing parameters (i)-(iv) pertain to respective ones of the at least two distinct air interfaces.

69. The apparatus of claim 41, wherein a first one of the at least two distinct air interfaces comprises one of a Wireless Wide Area Network (WWAN) air interface or a Wireless Local Area Network (WLAN) air interface.

70. The apparatus of claim 69, wherein a second one of the at least two distinct air interfaces comprises one of a Wireless Local Area Network (WLAN) air interface or a Wireless Wide Area Network (WWAN) air interface.

71. The apparatus of claim 41, further configured to operate the at least two distinct air interfaces in distinct portions of a radio spectrum, wherein the at least two air interfaces comprise a Wireless Wide Area Network (WWAN) air interface and a Wireless Local Area Network (WLAN) air interface.

72. The apparatus of claim 41, further configured to dynamically select between concurrent aggregation and robust modes of operation for the first IP data flow over the at least two distinct air interfaces.

73. The apparatus of claim 41, wherein information associated with a first sub-flow is retransmitted on an alternate sub-flow.

74. The apparatus of claim 41, wherein at least two distinct sub-flows can utilize different wireless communication channels for transporting data.

75. The apparatus of claim 41, wherein at least two distinct sub-flows can utilize the same wireless communication channel for transporting data.

76. The apparatus of claim 41, wherein the method is performed in a femto-cell or a WiFI access point, or in an integrated system comprising a femto-cell capability and an WiFi access point capability.

77. The apparatus of claim 41, wherein a second IP data flow is communicated over an MTP tunnel between the stations using at least two distinct sub-flows over two distinct air interfaces.

78. The apparatus of claim 41, wherein the MTP tunnel originates on the first station and terminates on the second station.

79. The method of claim 41, wherein the MTP tunnel maintains end-to-end connectivity between the stations over at least one air-interface during transient failure of wireless connectivity over other air-interfaces.

80. A computer program product, comprising:
a computer-readable medium comprising code for causing a computer to:
at a first station, wirelessly communicate with a second station via a multi-path transport protocol (MTP) tunnel component that manages at least two distinct IP data sub-flows over at least two distinct air interfaces, wherein the first station and the second station are in wireless communications range of each other via parallel ones of the at least two distinct air interfaces; and
allocate a first IP data flow to the at least two distinct IP data sub-flows over the at least two distinct air interfaces, using the MTP tunnel component of the first station.
